(19) United States
(12) Patent Application Publication
(10) Pub. No.: US 2009/0248470 A1
(43) Pub. Date: Oct. 1, 2009

(54) SYSTEM AND METHOD FOR MEASURING PERFORMANCE OF A CARRIER NETWORK

(75) Inventors: Leon A. Pintsov, West Hartford, CT (US); Andrei Obrea, Seymour, CT (US)

Correspondence Address: PITNEY BOWES INC., 35 WATERVIEW DRIVE, MSC 26-22, SHELTON, CT, 06484-3000, US

(73) Assignee: Pitney Bowes Inc, Stamford, CT (US)

(21) Appl. No.: 12/055,559

(22) Filed: Mar. 26, 2008

(51) Int. Cl. G06Q 10/00; G06Q 50/00

(52) U.S. Cl. 705/8

(57) ABSTRACT

System and methods for determining time-for-delivery for a mail piece based on the origin and destination of the mail piece are provided. A mail processing system is utilized by recipients of mail pieces to scan each incoming mail piece. The mail processing system extracts information from the mail piece that indicates the origin location of the mail piece as well as the date the mail piece was sent. The mail processing system establishes a record of the time-for-delivery between the origin location for each mail piece and the destination location. A data center aggregates the records from a plurality of different mail processing systems to establish a database that includes an actual value of time-for-delivery based on specific origin and destination locations. Mailers can then obtain information from the data center concerning actual time-for-delivery statistics based on the specific origin and destination of a mail piece.

### FIELD OF THE INVENTION

The invention disclosed herein relates generally to mail processing systems, and more particularly to networked mail processing systems that can be utilized to measure the performance of a carrier network.

### BACKGROUND OF THE INVENTION

Numerous postal systems have been developed around the world for the delivery of mail pieces, e.g., letters, flats, packages, and the like. Most postal systems provide guidelines with respect to a time-for-delivery, i.e., the time elapsed between depositing a mail piece with the postal system for delivery and actual delivery of the mail piece to its destination (sometimes also referred to as transit time). For example, the time-for-delivery may be specified as 2-3 days for a specified class of service. This delivery time, however, depends significantly on the origin and destination of the mail piece. It can be easily understood that a mail piece being sent across the country will take more time to be delivered than a mail piece being sent across the same state. In situations where a mailer needs a mail piece to be delivered within a specific time frame, it is difficult, based solely on the estimates provided from the postal system, for a mailer to determine the least expensive class of service that can be used for the mail piece while still meeting the delivery time goal.

It would be desirable, therefore, to be able to determine a time-for-delivery for a mail piece based on the origin and destination of the mail piece.

### SUMMARY OF THE INVENTION

The present invention alleviates the problems associated with the prior art and provides a system and method for determining time-for-delivery for a mail piece based on the origin location and destination location of the mail piece.

In accordance with the present invention, a mail processing system is utilized by recipients of mail pieces to scan each incoming mail piece. For those incoming mail pieces that are provided with indicators that provide the origin location of the mail piece as well as the date the mail piece was sent, the mail processing system obtains this information from each mail piece. Using the information obtained from the received mail pieces, along with the date of receipt of each of the mail pieces, the mail processing system establishes a record of the time-for-delivery between the origin location for each mail piece and the known location of the mail processing system. The mail processing system periodically sends the records to a data center. The data center aggregates the records from a plurality of different mail processing systems to establish a database that includes an actual value of time-for-delivery based on specific origin and destination locations. Mailers can then query the database maintained at the data center to obtain information concerning actual time-for-delivery statistics based on the specific origin and destination of a mail piece.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates a system according to an embodiment of the present invention;

FIG. 2 illustrates an example of a mail processing system according to an embodiment of the present invention;

FIG. 3 illustrates in flow chart form an example of the processing performed when a mail piece is received using the mail processing system;

FIG. 4 illustrates in flow chart form an example of processing performed by the data center according to an embodiment of the present invention; and

FIG. 5 illustrates in flow chart form an example of processing performed by the data center when a request for time-for-delivery is received.

### DETAILED DESCRIPTION OF THE PRESENT INVENTION

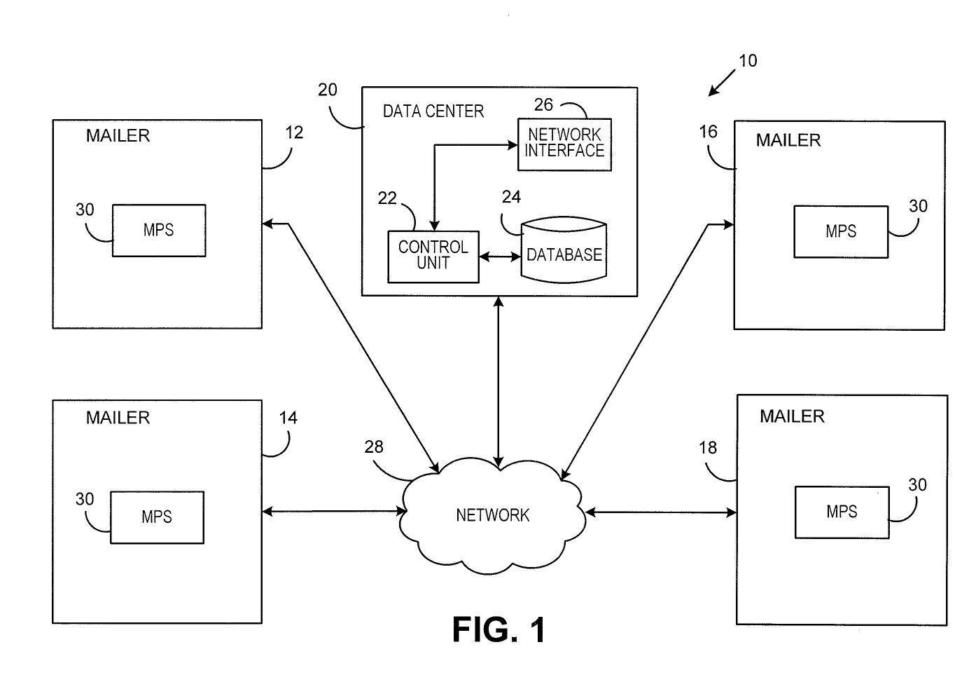

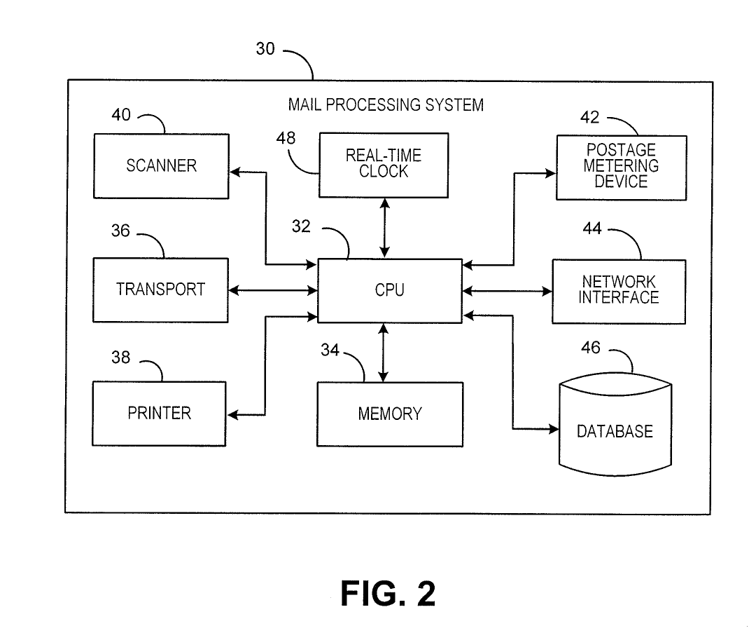

In describing the present invention, reference is made to the drawings, wherein there is seen in FIG. 1 a system 10 according to an embodiment of the present invention. System 10 includes a plurality of mailers, e.g., mailer 12, mailer 14, mailer 16, mailer 18. While only four mailers are illustrated in FIG. 1, it should be understood that any number of mailers may be part of the system 10. Each mailer 12-18 operates one or more mail processing systems (MPS) 30 (described further below with respect to FIG. 2) to process both outgoing and incoming mail.

Each of the mailers 12-18 is adapted to communicate with a data center 20. Such communications can be done utilizing any type of communication network 28, such as, for example, the Internet, a telephone network, or the like. Data center 20 preferably includes a control unit 22 and one or more databases 24, as will be described below. Control unit 22 can be, for example, a processing unit or the like that is adapted to control operation of the data center 20. Data center 20 includes a network interface 26 that provides the necessary communication hardware/software required for the data center 20 to communicate via the network 28 with the mail processing systems 30 operated by mailers 12-18.

FIG. 2 illustrates in block diagram form a mail processing system 30 that can be utilized by each of the mailers 12-18 of FIG. 1. Each mail processing system 30 can be, for example, a dedicated mailing machine or any other type of device that is utilized to process outgoing mail pieces that is adapted (as described below) to also process incoming mail pieces. There are many different types of mailing machines, ranging from relatively small units that handle only one mail piece at a time, to large, multi-functional units that can process hundreds of mail pieces per hour in a continuous stream operation. MPS 30 includes a central processing unit 32, which can include, for example, one or more special or general purpose processing devices. The CPU 32 controls operation of the MPS 30 using instructions stored in one or more memory units 34. The MPS 30 preferably includes a transport 36, such as, for example, rollers and belts, that automate the processing of mail pieces by transporting the mail pieces through the MPS 30. Such transport systems are well known in the art.

When processing outgoing mail pieces, the CPU 32 communicates with a postage metering device 42 that is utilized to generate indicia to evidence payment of postage for mail pieces and provide accounting data for communication to the data center 20 via network interface 44. Postage metering device 42 is preferably a secure coprocessor that performs cryptographic operations and keeps track of funds by maintaining a descending register which stores an amount of funds available for use and an ascending register which stores a total amount of funds dispensed over the life of the metering device 42. Funds may be added to the descending register by any conventional means. A printer 38 is used to print information on the mail pieces, such as, for example, indicia generated by the postage metering device 42, address information (either or both of the sender and recipient), ad slogans, and the like. Printer 38 may be, for example, an ink jet printer or other conventional type of printing device. The MPS 30 is adapted to process incoming mail pieces by having a scanning or reading device 40 to scan information printed on the mail pieces that are received by the mailer. A network interface 44 provides the necessary communication hardware/software required for the MPS 30 to communicate via the network 28 with data center 20. A real-time clock 48 provides the current date/time to the CPU 32. MPS 30 also preferably includes a memory or database 46 that is utilized to store information extracted from scanning the received mail pieces and the current date/time as described below.

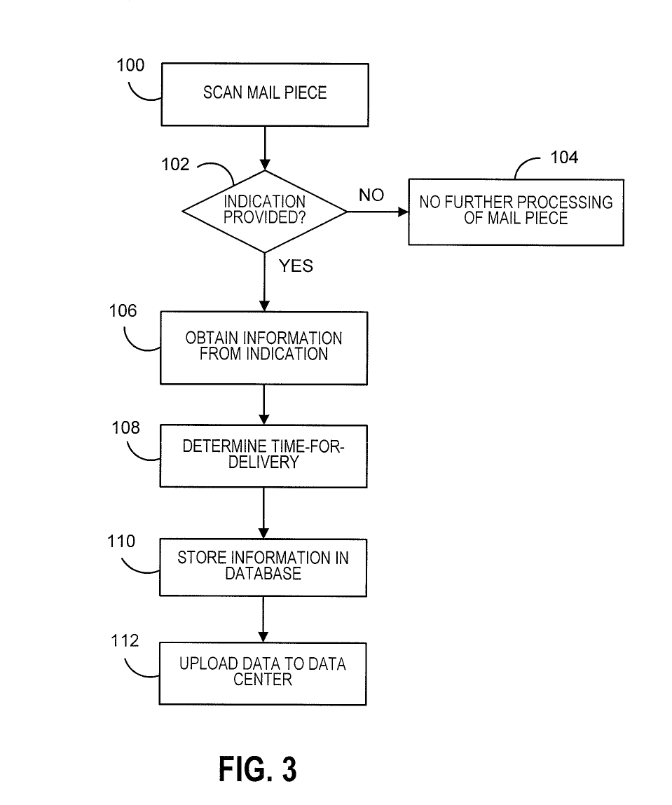

FIG. 3 illustrates in flow chart form an example of the processing performed during processing of incoming mail pieces. The process of FIG. 3 will be described with respect to a single mailer as illustrated in FIG. 1 operating a MPS 30 as illustrated in FIG. 2. It should be understood that such processing will be similar at every mailer location using similar mail processing systems. The processing begins in step 100 where a mail piece received by a mailer, e.g., mailer 12, is fed into the MPS 30 and scanned using the scanner 40 to obtain information provided on the face of the mail piece. Optionally, only those mail pieces that include an indication of its origin location and induction date may be fed into the MPS 30, as it is those mail pieces that are specifically utilized during the processing. There can be several different types of indicators that can provide such information. For example, one type is an information-based indicium, which is an indicium applied to mail being processed using the Information Based Indicia Program (IBIP) promulgated by the United States Postal Service (USPS). The indicium consists of a two-dimensional bar code and certain human readable information. Requirements for such an indicium can be found in the Information Based Indicia Program (IBIP) Indicium Specification, issued by the USPS on Jun. 13, 1996, the contents of which are incorporated herein by reference. As another example, an indictor could include a cancellation mark on regular stamped mail, which provides both the date the mark was printed (which typically corresponds to the induction date of the mail piece) along with the location of the induction (e.g., inducting post office zip code). The return address on the mail piece could also be used as an indication of the origin location. It should be noted that the present invention is not limited to using the above examples, and that any type of indicator that provides the date of induction and origin location is suitable for use.

Removing those mail pieces that do not include an indication of induction date and origin location before feeding into the MPS 30 would require additional sorting on the part of the operator of the MPS 30, and therefore may not be as desirable. Preferably, all of the received mail pieces would be fed into the MPS 30, and after a mail piece is scanned in step 100, then in step 102 it is determined, using for example, one or more processing routines performed by the CPU 32, if the information on the mail piece includes an indication of induction date and origin location. This can be performed, for example, by determining if there is a two-dimensional barcode, as required by the Indicium Specification, provided on the mail piece, or if the mail piece is provided with a stamp that has been canceled. Optical character recognition processing could also be utilized to determine if an induction date is provided on the mail piece in a known format for date representation. If an indication of the induction date and origin location is not provided on a mail piece, then in step 104 no further processing is performed on the mail piece with respect to the present invention, as it typically would not contain suitable information to be of use.

If in step 102 it is determined that a mail piece contains an indication of the date of induction and origin location, then in step 106 the indication information that is provided on the mail piece is obtained. In the case of an IBI indicia, the information is preferably obtained from the two-dimensional barcode, but can also be obtained from the human-readable portion as well. For an IBI, the origin location is deemed to be, for example, the licensing zip code, i.e., the zip code in which the mail processing system that generated the IBI for the mail piece is registered (and typically the origin location where the mail piece was inducted into the carrier network) and the induction date is deemed to be, for example, the date that the IBI was generated (which is included in the IBI). For a cancellation mark, the origin location is deemed to be, for example, the location of the postal facility where the mail piece was inducted (as provided in the cancellation mark) and the induction date is deemed to be, for example, the date of the cancellation mark. Typically, the origin location can be expressed as a postal zip code, but can also be expressed as a geographic location or area as well. Optionally, in step 106 other information that may be provided on the mail piece could also be obtained, such as, for example, class or type of mail, postage amount, etc. for use as described below.

In step 108, the time-for-delivery is determined for the mail piece based on the difference between the induction date obtained from the mail piece and the current date as indicated by the real-time clock 48. Optionally, the determination of the time-for-delivery can take into account weekends, holidays, or other days typically designated as non-business days, such that the time-for-delivery is based only on regular business days, e.g., Monday thru Friday. Thus, for example, if a mail piece is mailed on a Friday and received on a Monday, the time-for-delivery would not include the intervening weekend days (Saturday and Sunday) and would instead be calculated as one day. In some situations, it is possible that more than one mail piece will be received from the same origin location. In most instances, the determined time-for-delivery would be the same, but in the event that differences exist the differences can be reconciled by the CPU 32 taking, for example, an average of the time-for-delivery for each of the mail pieces received from the same origin location. In this manner, there is only a single time-for-delivery value associated with each origin location.

In step 110, CPU 32 will store the obtained and calculated data, or portions thereof, in the database 46. One such way to store this information is to populate the fields in a table maintained in the database 46, including the origin location (e.g., based on the licensing zip code obtained from the IBI), the destination location (known from the location where the mail piece was received and the MPS 30 that is processing the mail piece) and the calculated time-of-delivery. An example of a portion of such a table is provided below as Table 1, which illustrates an example of some mail pieces received on Feb. 27, 2008.

TABLE 1

| | | Time-for- | | |
|---|---|---|---|---|
| | | Delivery, | | |
| Origin | Destination | Business | | |
| Location | Location | days | Date mailed | Date Received |
| 06926 | 06468 | 1 day | Feb. 26, 2008 | Feb. 27, 2008 |
| 10956 | 06468 | 2 days | Feb. 25, 2008 | Feb. 27, 2008 |
| 90012 | 06468 | 4 days | Feb. 20, 2008 | Feb. 27, 2008 |
| 46614 | 06468 | 3 days | Feb. 22, 2008 | Feb. 27, 2008 |

It should be understood, of course, that the table above is exemplary only, and not all of the information need be included, e.g., date mailed or date received. Additionally, if other information was obtained from mail pieces, this other information could also be included if desired, such as, for example, the class of service, type of mail (letter, flat, parcel), postage amount, etc. The location entries in Table 1 are based on zip codes, but other location identifiers could also be provided, e.g., town or city names, other types of postal codes, etc. The entries in Table 1 are also based on the CPU 32 taking into account designated non-business days in the determination of the time-for-delivery. Thus, for the mail piece arriving from California (Origin Zip Code 90012), although the elapsed time from date mailed to date received is seven days, the actual time-for-delivery is only four business days.

In step 112, the MPS 30 sends the data, or portions thereof, to the data center 20 via the network 28. The uploading of the data can occur on a regular basis, e.g., daily, or periodically, e.g., weekly, bi-weekly, monthly, etc. Preferably, the data is uploaded daily to provide real-time data for use by the data center 20. If the data is stored in a table as described above, the table could be uploaded to the data center 20. Optionally, the data being sent from the MPS 30 to the datacenter 20 could be cryptographically protected for privacy or data integrity/authentication purposes, such as, for example, by encryption or use of a digital signature.

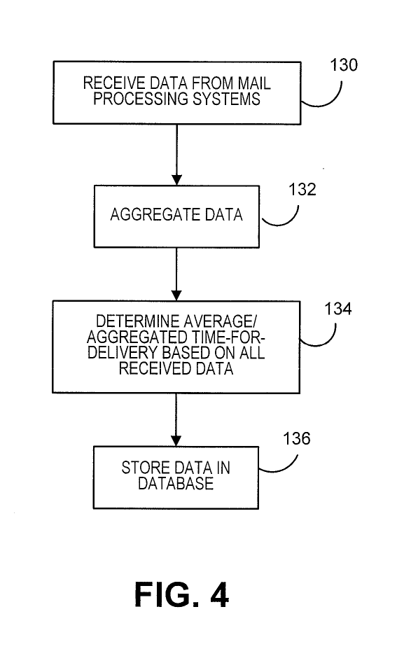

FIG. 4 illustrates in flow chart form processing performed by the data center 20 when data is received from mail processing systems. In step 130, the data center 20 receives data, via the network 28, collected by a plurality of mail processing systems as described with respect to FIG. 2. As noted above, the data can be received on a daily basis, weekly basis, or any other time period as desired. In step 132, the control unit 22 of the data center 20 aggregates all of the data received from each of the different mail processing systems. In some situations, it is possible that two or more mail processing systems that are providing data may be located in the same destination location. In this situation, it is also possible that each of the mail processing systems may have processed mail received from the same origin location, and therefore each mail processing system will include a time-for-delivery for the same origin and destination of a mail piece. In most cases, the time-for-delivery determined by each of those mail processing systems would be the same, but in some instances it may vary by a day or two. Accordingly, to account for such differences should they occur, in step 134, the control unit 22 can preferably determine a time-for-delivery based on all the received data having the same origin location and destination location. For example, an average or a distribution for transit time could be calculated based on all of the received data.

In step 136, the time-for-delivery data that has been received from the mail processing systems, and, if applicable, determined by the control unit 22, is stored in the database 24 of the data center 20. Such data could be stored in the form of a look-up table that identifies an origin location, a destination location and the time-for-delivery based on the data received from all of the mail processing systems that are part of the system 10. Optionally, other information obtained from mail pieces could also be included to provide additional data, e.g., class off service, type of mail, etc. In the event that data already exists in the look-up table for a specified origin location to destination location, preferably the time-for-delivery currently in the look-up table would be replaced by the time-for-delivery from the most current data received by the data center 20. In this manner, the time-for-delivery values maintained in the database 24 will be the most up-to-date and accurate. As new data is obtained by the data center 20, additional rows can be added to the look-up table to include the new entries (origin location and/or destination location). Alternatively, information can be aggregated either using an average over a period of time, a sliding window, removal of outliers, or any other suitable method. Over time the number of entries in the table will increase, based on the participation of large numbers of mail processing systems, such that the look-up table can contain the time-for-delivery values for a very large number of origin-to-destination locations. It should be noted that the time-for delivery maintained by the data center 20 will be a very good approximation of actual delivery time, i.e., into the hands of a human recipient, as opposed to delivery times provided by more traditional tracking systems that measure time elapsed between mail items being at two different locations in the postal delivery network.

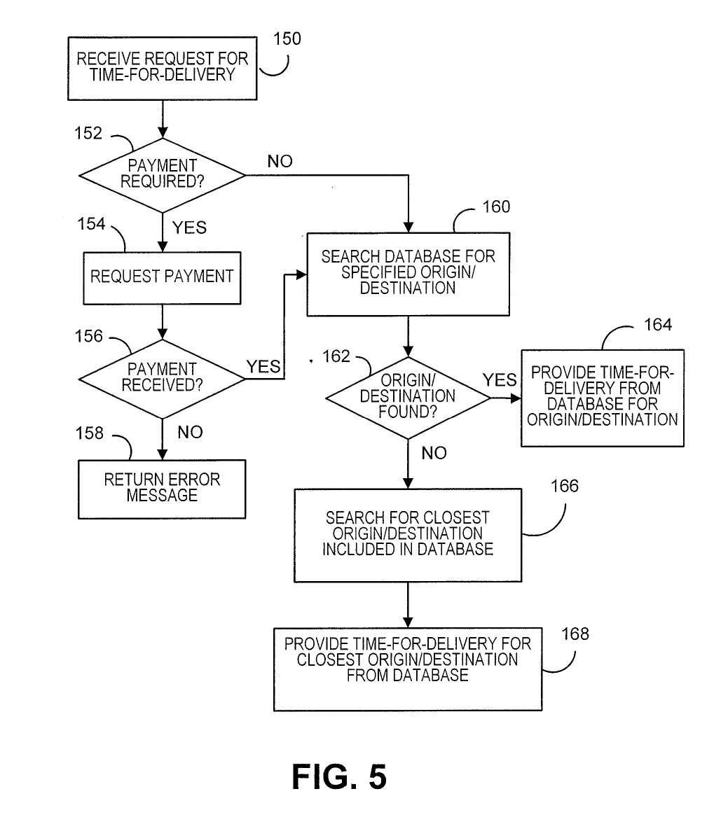

With the data stored in the database 24, the data center 20 can provide mailers with actual time-for-delivery values. FIG. 5 illustrates the processing performed by the data center 20 when performing such a service. In step 150, the data center 20 receives a request for the time-for-delivery from a specified origin to destination. Such a request can come from a mailer using a mail processing system 30 via the network 28. Alternatively, the data center 20 could establish a website on the network that can be accessed by any personal computer that has access to the network 28. As noted above, the request includes the origin location of the mail piece and the destination location of the mail piece. In step 152, it is determined if payment is required from the requesting party. Payment may not be required, for example, from mailers that provide data to the data center to maintain the database 24, e.g., mailers 12-18. Thus, only those parties that desire to use the information without contributing may be required to pay for access to the information. If in step 152 it is determined that payment is required, then in step 154 payment is requested. In step 156 it is determined if payment is received from the requesting party. Payment could be, for example, via a credit card or by any other on-line payment methods. If payment is required from mailers using a mail processing system 30, payment could be deducted directly from the postage metering device 42. Payments could be sent via the data center 20, or exchanged directly between MPS 30 of mailers 12, 14, 16 and 18. If in step 156 it is determined that proper payment has not been received, then in step 158 an error message will be returned to the requestor, and the processing ends until a new request is received.

If in step 152 it is determined that payment is not required, or if in step 156 it is determined that payment is received, then in step 160 the control unit 22 will search the database 24 for data that corresponds to the origin/destination specified in the request. In step 162 the control unit 22 will determine if data that corresponds to the origin/destination specified in the request has been found in the database 24, and if so, then in step 164 the data center 20 will provide the time-for-delivery for the origin/destination that is stored in the database 24. If in step 162 it is determined that there is no data in the database 24 that corresponds to the origin/destination pair specified in the request, then in step 166 the control unit 22 can perform a search of the database 24 for the origin and/or destination that is closest to the origin/destination in the request. For example, there may be data from the actual origin specified in the request, but only to a destination that is near to the actual destination specified in the request. Similarly, there may be data for an origin that is near the actual origin specified in the request to the actual destination specified in the request. Depending upon the proximity of the origin/destination to the origin/destination specified in the request, the time-for-delivery data may still be accurate enough for use. The proximity may take into account the actual postal network as two geographically close locations may be served by postal units with considerably different performance. In step 168, the data center will provide the time-for-delivery for the closest origin/destination stored in the database 24 to the origin/destination included in the request. Preferably, this will also include the specific origin and destination locations, thereby indicating that the time-for-delivery is not actual data for the origin/destination specified in the request. As an alternative to steps 166 and 168, if a corresponding entry for the origin/destination does not exist in the database 24, an error message could be returned, and any payments, if made, can be refunded to the requesting party. Thus, a mailer is able to obtain actual time-for-delivery values based on a specific origin location and destination location for a mail piece.

Thus, according to the present invention, a data center aggregates time-for-delivery values from a plurality of different mail processing systems to establish a database that includes an actual value of time-for-delivery based on specific origin and destination locations. Mailers can then query the database maintained at the data center to obtain information concerning actual time-for-delivery statistics based on the specific origin and destination of a mail piece.

While preferred embodiments of the invention have been described and illustrated above, it should be understood that they are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A mail processing system for processing a received mail piece, the mail processing system having a designated destination location that identifies a location of the mail processing system, the system comprising:
a scanning device to scan the received mail piece and obtain information provided on the received mail piece, the information including an origin location and a date of mailing for the received mail piece;
a clock unit to provide a current date;
means for determining a time-for-delivery from the origin location to the destination location for the received mail piece based on the date of mailing obtained from the information provided on the received mail piece and the current date provided from the clock unit;
means for storing in the mail processing system the determined time-for-delivery from the origin location to the destination location for the received mail piece; and
means for sending from the mail processing system to a remote data center the determined time-for-delivery from the origin location to the destination location for the received mail piece.

2. The system of claim 1, wherein the mail piece includes an information based indicium, and the origin location and the date of mailing for the received mail piece are obtained from the information based indicium.

3. The system of claim 1, wherein the means for determining the time-for-delivery further comprises:
means for determining the time-for-delivery based only on regular business days.

4. A method for processing a received mail piece using a mail processing system, the mail processing system having a designated destination location that identifies a location of the mail processing system, the method comprising:
scanning the received mail piece to obtain information provided on the received mail piece, the information including an origin location and a date of mailing for the received mail piece;
determining a time-for-delivery for the received mail piece from the origin location to the destination location based on the date of mailing obtained from the information provided on the received mail piece and a current date provided from a clock within the mail processing system;
storing in the mail processing system the determined time-for-delivery from the origin location to the destination location for the received mail piece; and
sending from the mail processing system to a remote data center the determined time-for-delivery from the origin location to the destination location for the received mail piece.

5. The method of claim 4, wherein the mail piece includes an information based indicium, and the origin location and a date of mailing for the received mail piece are obtained from the information based indicium.

6. The method of claim 4, wherein determining the time-for-delivery further comprises:
determining the time-for-delivery based only on regular business days.

7. The method of claim 4, wherein the information further includes a class of service for the received mail piece, and the determined time-for-delivery from the origin location to the destination location is associated with the class of service.

8. A method of operating a data center comprising:
receiving data from a plurality of mail processing systems that process received mail, the data including a time-for-delivery from an origin location to a destination location for mail pieces processed by each mail processing system;
aggregating the data received from the plurality of mail processing systems; and
storing the data received from the plurality of mail processing systems in a database.

9. The method of claim 8, wherein after the data is aggregated, the method further comprises:
determining a time-for-delivery based on all received data having a similar origin location and destination location.

10. The method of claim 8, further comprising:
receiving a request for a time-for-delivery for a mail piece, the request including a specified origin location and destination location for the mail piece;
searching the database for data that corresponds to the specified origin location and destination location included in the request; and
providing the time-for-delivery stored in the database that corresponds to the specified origin location and destination location included in the request.

11. The method according to claim 10, wherein if the database does not include data that corresponds to the specified origin location and destination location, the method further comprises:
searching the database for data that corresponds to a closest origin location and destination location as the specified origin location and destination location; and
providing the time-for-delivery stored in the database that corresponds to the closest origin location and destination location as the specified origin location and destination location.

12. The method according to claim 10, further comprising:
receiving payment for providing the time-for-delivery stored in the database.

13. The method according to claim 12, wherein the payment is provided from a register maintained in a mail processing system.

14. The method according to claim 9, wherein the request further includes a specified class of service for the mail piece, and the provided time-for-delivery is based on the specified class of service.

15. The method according to claim 9, wherein the request further includes a specified type of mail piece, and the provided time-for-delivery is based on the specified type of mail piece.
